(19) United States
(12) Patent Application Publication
(10) Pub. No.: US 2015/0174864 A1
(43) Pub. Date: Jun. 25, 2015

(54) SELF-FUSING CARBON FIBER SILICONE PERFORATED TAPE

(71) Applicant: Midsun Group Inc., Southington, CT (US)

(72) Inventors: Mark Hatje, Chesire, CT (US); John Poplawski, Meridan, CT (US)

(21) Appl. No.: 14/597,294

(22) Filed: Jan. 15, 2015

Related U.S. Application Data
(63) Continuation-in-part of application No. 13/273,405, filed on Oct. 14, 2011.

(51) Int. Cl. B32B 25/20; B32B 25/08; B32B 25/10; B32B 3/26; B32B 5/02

(52) U.S. Cl. CPC B32B 25/20; B32B 3/266; B32B 5/02; B32B 25/10; B32B 25/08; B32B 2262/106

(57) ABSTRACT

A tape product having an elongated strip of silicone material and a polyester film that covers the upper portion of the elongated strip, the elongated strip and the polyester film having through holes across the width of the strip, the through holes repeated at intervals along the length of the tape, such that a pull of the tape in a longitudinally direction separates the elongated strips of silicone rubber self-fusing tape into tape segments. In an alternate embodiment the tape contains two elongated strips and an interposed carbon fiber thread, and the through holes repeated at intervals along the length of the tape, cuts the thread and the tape such that a pull of the tape in a longitudinally direction separates the elongated strips of silicone rubber self-fusing tape into tape segments.

### CROSS-REFERENCE TO RELATED APPLICATIONS

This is a continuation-in-part claiming the priority benefit under 35 U.S.C. 120 of U.S. patent application Ser. No. 13/273,405 entitled Self-Fusing Carbon Fiber Silicone Tape And Manufacturing Process, filed Oct. 7, 2011, the entire disclosure of which is hereby incorporated by reference.

### FIELD OF INVENTION

The present invention relates generally to self-fusing silicone tape for commercial and industrial applications.

### BACKGROUND

Self-fusing silicone rubber tape is a rubber-like material composed of silicone, a polymer, containing silicon together with carbon, hydrogen, and oxygen. These tape products are used in applications, such as civil engineering, military, aerospace, plumbing, construction and repair, where the need exists for tape solutions that are non-reactive, stable, and resistant to temperatures from 55° C. to +300° C., while maintaining its useful properties. Non-dyed silicone rubber tape with an iron-oxide additive (making the tape a red-orange color) is used extensively in aviation and aerospace wiring applications as a splice or wrapping tape due to its non-flammable nature. The iron-oxide additive adds high thermal conductivity, but does not change the high electrical insulation property of the silicone rubber. This type of silicone tape self-fuses or amalgamates without any added adhesive.

In order to keep the tape from fusing with the surface of tape above and below when the tape is rolled, a protective coating, typically composed of a polyester film such as Mylar, is applied to serve as an interleaf between tape layers as they are formed around a core to form a roll of tape (Mylar is a registered trademark for a polyester film, owned by DuPont Teijin Films).

Organic rubber has a carbon to carbon backbone which leaves them susceptible to ozone, UV, heat and other ageing factors that silicone rubber withstands well. At the extreme temperatures, the tensile strength, elongation, tear strength and compression set can be far superior to conventional rubbers although still low relative to other materials. However, compared to organic rubbers, silicone rubber tape has a very low tensile strength. For tape products that need to withstand even relatively low imposed loads, there is a need for a self-fusing tape that has a relatively high tensile strength. As used herein, the term “tensile strength” is a quantitative measure of the pulling force a certain length of tape can exert without breaking. The definition of tensile strength must be contrasted from “modulus of elasticity.” The term “modulus of elasticity” as used here means a measure of a tape's resistance to stretching, the higher the number, the stiffer its resistance to stretching. In many silicone tape applications, a least tape resistance to stretching is preferred. Therefore, one improvement to a silicone tape should maximize modulus of elasticity and wherever possible improve the elastic limit, or yield strength, i.e., where a permanent deformation in a silicone tape occurs. Another improvement to a silicone tape should resist tearing when applied to the object to which it is intended to support.

Carbon fiber is comprised of thin strands measuring between 0.005-0.010 mm in diameter and composed mostly of carbon atoms. The carbon atoms are bonded together in microscopic crystals that are more or less aligned parallel to the long axis of the fiber. The crystal alignment makes the fiber very strong for its size.

Notably several thousand carbon fibers twisted together form a thread or yarn, which is, as more fully described below, used in the invention herein to create a tape product that improves the tensile strength by embedding the carbon fibers between layer of self-fusing silicone tape, while keeping the “modulus of elasticity” unchanged from the silicone tape products that do not contain the feature of having embedded carbon fibers.

When a silicone tape product has a particularly high tensile strength, high modulus of elasticity and high elastic limit, as this product is intended to have, especially in the carbon fiber enhanced product, and even when not enhanced by carbon fiber, but simply employing the Mylar backing, it makes it difficult for the user (e.g., the mechanic or technician) to apply the tape in certain applications, because it resists tearing. In these situations, the user must cut the tape with either a scissor, serrated edge or a knife. Many applications would benefit if a tape product were to include a means to separate its length into usable strips.

### SUMMARY OF THE INVENTION

This invention relates to a tape product that includes upper and lower opposing elongated strips of silicone rubber self-fusing tape, having therebetween a carbon fiber thread contained by fusing the interior surfaces of the strips of silicone rubber, the fiber thread having a transverse spatial pattern that cyclically crosses a longitudinal centerline of the width of the strip, such that the thread increases the tensile strength and the tear resistance of the tape, while insuring the elastic limit of the strips of tape is maintained. A cover contacts one of the elongated strips, the cover and the upper and lower portions of silicon tape having through holes or perforations across their width, the through holes repeated at intervals along the length of the cover and the tape, where a first through hole across the width of the strip cuts the thread to establish a commencement of the thread, and where a second through hole at the next subsequent repeated interval of through holes across the width of the strip along the length of the tape cuts the thread to establish a terminus of the thread, such that a pull of the tape in a longitudinally direction separates the elongated strips of silicone rubber self-fusing tape and cover into segments.

A tape product includes an elongated strip of silicone rubber self-fusing tape, having an iron-oxide additive contained therein, and a polyester film that covers the upper portion of the elongated strip, the elongated strip and the polyester film having at least three through holes across the width of the strip, the through holes repeated at intervals along the length of the tape, such that a pull of the tape in a longitudinally direction separates the elongated strips of silicone rubber self-fusing tape into tape segments.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts, and wherein:

FIG. 1A is an end-view of the self-fusing tape with an embedded carbon fiber according to an embodiment of the present invention;

FIG. 1B is a top sectional view A-A and end view of the self-fusing tape with an embedded carbon fiber according to an embodiment of the present invention;

FIG. 2 is a perspective view of the self-fusing tape with an embedded carbon fiber according to an embodiment of the present invention;

### DETAILED DESCRIPTION

It is to be understood that the figures and descriptions of the present invention have been simplified to illustrate elements that are relevant for a clear understanding, while eliminating, for the purpose of clarity, many other elements found in the self-fusing tape with an embedded carbon fiber technology, methods of using the same and its manufacture. Those of ordinary skill in the art may recognize that other elements and/or steps may be desirable in implementing the present invention. However, because such elements and steps are well known in the art, and because they do not facilitate a better understanding of the present invention, a discussion of such elements and steps is not provided herein.

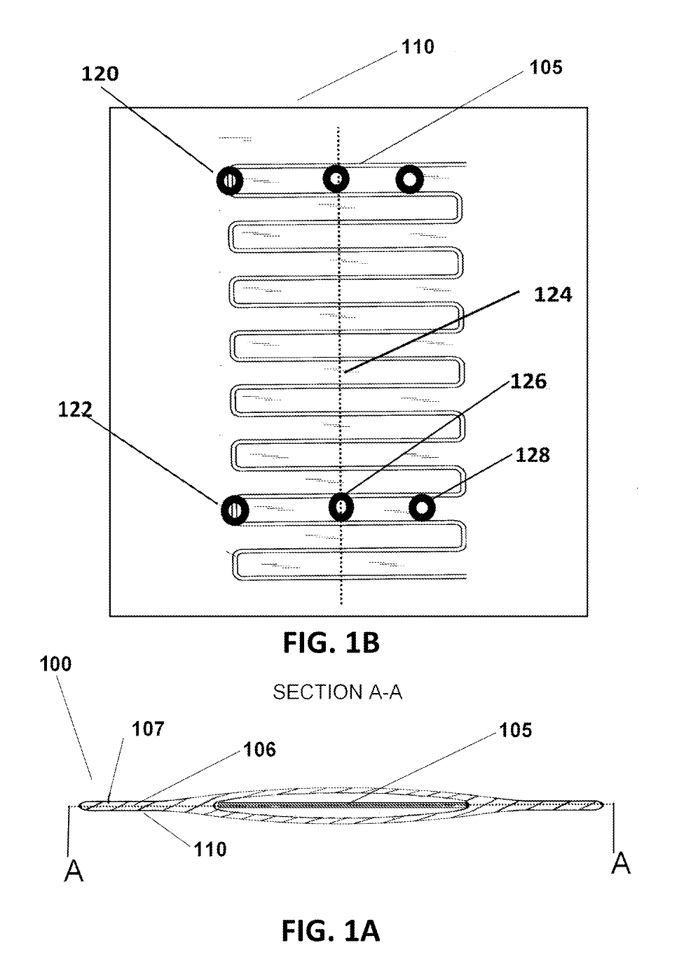

FIG. 1A illustrates one embodiment according to an embodiment of the present invention of a self-fusing tape 100 with an embedded carbon fiber 105. An elongated top layer of silicone tape 107 and a bottom layer of silicone tape 110 serve to encapsulate the carbon fiber thread 105. Various patterns of the thread, dependent on design factors, laid between the silicone tape layers, 107, 110 will serve to achieve desired tensile strengths, increase tear resistance and preserve the elastic limit of the silicone elongated strips.

In FIG. 1B, a cross sectional view A-A illustrates a pattern of straight horizontal lines progressing in fixed vertical steps. The steps may be any length, satisfying a design choice dependent on the tensile strength and the elastic limit of the silicone tape.

One embodiment of the invention relates to the tape product 100 including two opposing elongated strips of silicone rubber 107, 110, and interposed therein the carbon fiber thread 105 having a transverse spatial pattern such that the thread increases the tensile strength and increases the tear resistance while maintaining the elastic limit of the strips of self-fusing tape. The incorporation of the carbon fiber in itself increases the tear resistance of the product, since the carbon fiber thread 105 is virtually impossible to break. However, because the carbon fiber thread runs through the tape lengthwise, the tape is virtually impossible to tear and must be cut with a scissor or other tool. In the present disclosure the through holes, such as through hole 120, 126 and 128 allow the tape to be torn into useable strips.

The embodiments by way of example and not limitation of thread patterns may be as an “S,” pattern as shown in FIG. 1B, triangular (not shown), or a “Z” pattern (not shown), dependent on the desired tensile strength and modulus of elasticity.

As with the tape itself, the polyester film that covers the upper elongated strip (typically a Mylar ° backing, makes it difficult to use the product in certain applications because it resists tearing, and must be cut with either a scissor, serrated edge or a knife.

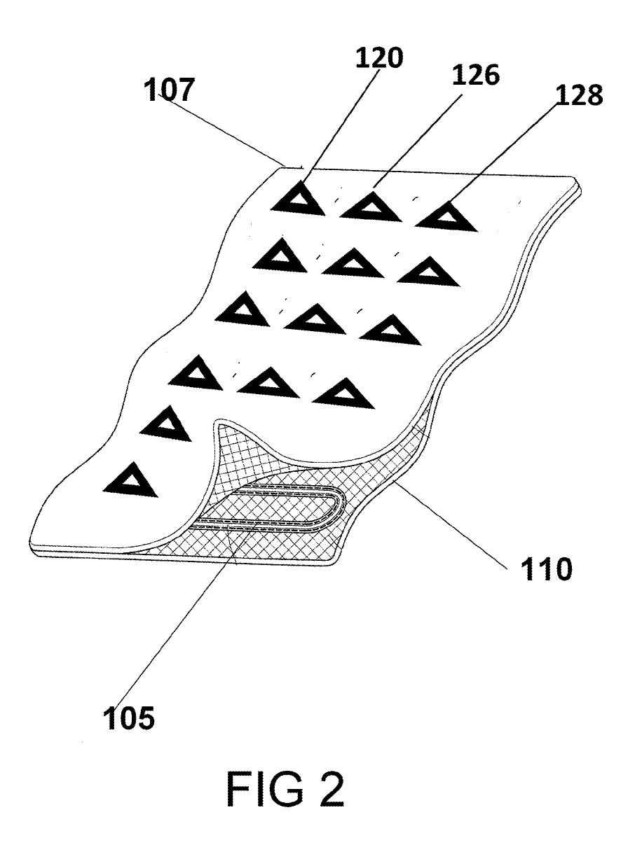

FIG. 2 is a perspective cut-away view according to an embodiment of the present invention of the self-fusing tape with an embedded carbon fiber showing the top layer of silicone tape 107 and the bottom layer of silicone tape 110 that serve to encapsulate the carbon fiber thread 105. Triangle shaped perforations as shown in FIGS. 2, 120, 126 and 128 allow the tape and liner to tear easily by hand. It is easier to apply the tape to it intended object by using small pre-cut pieces instead of cutting pieces from a whole roll or wrapping with an entire roll of tape and liner in users hand. The through holes may be any shape, circular, triangle or square, depending on the shape of the die that creates the hole.

In one non-limiting embodiment the upper and lower opposing elongated strips of silicone rubber self-fusing tape and the polyester film that covers the upper elongated strip have a set of perforations, where at least one perforation cuts the fiber thread as shown in FIG. 1B, 120. In another non-limiting embodiment the perforations are made at the central location, e.g., the longitudinal centerline 124 relative to the width of the tape. Other carbon fiber patterns, such as a Z shaped pattern will cross the longitudinal centerline 124 at an angle, and a perforation, such as perforation 126, on the centerline, will cut the fiber. FIG. 1B, 120 shows the commencement of a thread segment, and where a second through hole at the next subsequent repeated interval of through holes across the width of the strip along the length of the tape cuts the thread, as shown by perforation 122 establishes a terminus of the thread.

The synchronization of the position of the thread relative to the application of the perforation, such that the thread is cut in the proper place, is well known to those of ordinary skill in the art of machinery design and construction.

In one non-limiting embodiment, there may be a few as three perforations across the width of the tape, and in other applications dozens of perforations, each set spaced apart every few inches to every few feet. In certain applications the perforations are on the order of less than a millimeter in diameter and may be difficult to see in the environments where the tape is used. To permit the user to see where the perforations are in one embodiment, the tape has incorporated thereon a printed indicator or “witness mark” in close proximity to the perforations to make the “perforated tear point” easily visible and identifiable to the user. In some instances the witness mark is visible under special illuminations, such as ultraviolet light.

In another embodiment of the tape product a single elongated strip of silicone rubber self-fusing tape, contains an iron-oxide additive. The strip is in intimate contact with the polyester film that covers the upper portion of the elongated strip. The elongated strip and the polyester film have through holes across the width of the strip, which are repeated at intervals along the length of the tape, such that a pull of the tape in a longitudinally direction separates the elongated strips of silicone rubber self-fusing tape into tape segments.

The self-fusing silicone tape 100 suitable for the top layer of silicone tape 107 and the bottom layer of silicone tape 110 meets the requirements of: operating at a continuous temperature between −64° C. to +260° C.; having a tensile strength of 700 psi minimum (ASTM-d-412 standard testing), thickness tolerances +/−, 002″ width +/−0.0625″; ultimate elongation 300% minimum (ASTM d-412 standard testing); and a tear resistance 85 psi. A self-fusing silicone tape manufactured and sold under the registered trademark Tommy Tape, by Midsun Specialty Products, Berlin Conn. meets the aforementioned requirements of the elongated silicone self-fusing material.

While the present invention has been described with reference to the illustrative embodiments, this description is not intended to be construed in a limiting sense. Various modifications of the illustrative embodiments, as well as other embodiments of the invention, will be apparent to those skilled in the art on reference to this description. It is therefore contemplated that the appended claims will cover any such modifications or embodiments as fall within the true scope of the invention.

1. A tape product comprising upper and lower opposing elongated strips of silicone rubber self-fusing tape, having therebetween a carbon fiber thread contained by fusing the interior surfaces of the strips of silicone rubber, the fiber thread having a transverse spatial pattern that cyclically crosses a longitudinal centerline of the width of the strip, such that the thread increases the tensile strength and the tear resistance of the tape, while insuring the elastic limit of the strips of tape is maintained, and a cover contacting one of the elongated strips, the cover and the upper and lower portions of silicon tape having through holes or perforations across their width, the through holes repeated at intervals along the length of the cover and the tape, where a first through hole across the width of the strip cuts the thread to establish a commencement of the thread, and where a second through hole at a subsequent repeated interval of through holes across the width of the strip along the length of the tape cuts the thread to establish a terminus of the thread, such that a pull of the tape in a longitudinally direction separates the elongated strips of silicone rubber self-fusing tape and cover into segments.

2. A tape product comprising two opposing elongated strips of silicone rubber self-fusing tape having interposed therebetween at least one-thousand carbon fibers twisted together to form a carbon fiber thread, the thread encapsulated into the silicone rubber upon application of a contact heat to fuse the interior surfaces of the strips of silicone rubber, the fiber thread having a transverse spatial pattern that cyclically crosses a longitudinal centerline of the width of the strip, such that the thread increases the tensile strength and the tear resistance of the tape, while insuring the elastic limit of the strips of tape is maintained, and a polyester film that covers the one of the elongated strips, the upper and lower opposing elongated strips and the polyester film having at least three through holes across the width of the tape strip, the through holes repeated at intervals along the length of the tape, where a first through hole of the at least three through holes across the width of the strip cuts the thread to establish a commencement of the thread, and where a second through hole at a subsequent repeated interval of three through holes across the width of the strip along the length of the tape cuts the thread to establish a terminus of the thread, such that a pull of the tape in a longitudinally direction separates the elongated strips of silicone rubber self-fusing tape into tape segments.

3. A tape product comprising: an elongated strip of silicone rubber self-fusing tape, having an iron-oxide additive contained therein, and a polyester film that covers the upper portion of the elongated strip, the elongated strip and the polyester film having at least three through holes across the width of the strip, the through holes repeated at intervals along the length of the tape, such that a pull of the tape in a longitudinally direction separates the elongated strips of silicone rubber self-fusing tape into tape segments.

4. The tape product claim 1, wherein the elongated strips of silicone produce a self-fusing tape.

5. The tape product claim 1, wherein the transverse spatial pattern is substantially in the form of rectangular steps.

6. The tape product claim 1, wherein the transverse spatial pattern is substantially in the form of triangular steps.

7. The tape product claim 1, wherein the transverse spatial pattern is substantially in an “S” shape.

8. The tape product claim 1, wherein the transverse spatial pattern is substantially in an “Z” shape.

9. The tape product claim 1, wherein the silicone rubber operates at a continuous temperature substantially between −64° C. to +260° C.

10. The tape product claim 1, wherein the silicone rubber has a tensile strength exceeding 700 psi.

11. The tape product claim 1, wherein the silicone rubber has an ultimate elongation of substantially 300% minimum.

12. The tape product claim 1, wherein the silicone rubber has a minimum tear resistance of 85 psi.

13. The tape product claim 1, wherein the cut of the thread to establish a commencement of the thread and the terminus of the thread occurs at the centerline of the thread.

14. The tape product claim 1, wherein an indicator is marked in close proximity to the perforations to make the perforated tear point visible and identifiable to a user.

15. The tape product claim 1, wherein the perforation of the thread is located on a center line, flanked by at least two perforations on either side.

16. The tape product claim 1, wherein the cover is comprised of a polyester film.

17. The tape product claim 14, where in the indicator is visible under special illumination.
